(19) United States
(12) Patent Application Publication
(10) Pub. No.: US 2022/0405445 A1
(43) Pub. Date: Dec. 22, 2022

(54) METHOD FOR AUTOMATED DESIGN AND FOR MANUFACTURE OF MECHANICAL ACTUATORS BY USING OF TOPOLOGICAL TRUSS-BASED METAMATERIALS

(71) Applicant: UNIVERSITA’ DEGLI STUDI DI MILANO, Milano (IT)

(72) Inventors: Silvia BONFANTI, MILANO (IT); Roberto GUERRA, MILANO (IT); Stefano ZAPPERI, MILANO (IT)

(21) Appl. No.: 17/777,324

(22) PCT Filed: Nov. 17, 2020
(86) PCT No.: PCT/IB2020/060813

§ 371 Date: May 17, 2022

(30) Foreign Application Priority Data
Nov. 19, 2019 (IT) 102019000021618

(51) Int. Cl. G06F 30/23; G06F 30/17

(52) U.S. Cl. CPC G06F 30/23; G06F 30/17; G06F 2113/10

(57) ABSTRACT

Described a computer-implemented method for the automated design of a mechanical actuator by using metamaterials. The method comprises: defining an initial lattice model of the metamaterial, constituted by the repetition of basic geometric elements formed by a plurality of nodes connected by a plurality of beams; defining several groups of nodes; and iterating a series of steps, including: modifying a current test lattice, on the basis of a pseudo-random decision determined by means of a computational algorithm; simulating, by means of computational simulation, the mechanical response of the modified test lattice; calculating a figure of merit of the modified test lattice on the basis of positions of input and output nodes in presence of an input mechanical stimulus; either accepting or rejecting the modified test lattice; and finally defining the current test lattice for the subsequent iteration is as the initial lattice at the first iteration.

### FIELD OF APPLICATION

The present invention generally relates to the technical field of designing and manufacturing mechanical actuators using metamaterials.

In particular, the invention relates to computer-implemented computational methods to design “topological” metamaterial lattices (or grids) capable of performing predetermined mechanical operations and providing predefined responses between an input mechanical bias and an output mechanical action.

In other words, the present invention relates to the design of structures having a desired input/output mechanical response, no matter how complex, using computational optimization algorithms.

### DESCRIPTION OF THE PRIOR ART

In the technical field mentioned above, mechanical metamaterials (or metamaterials) are known, i.e., a new class of man-made materials with very advantageous properties and functions which are hard to find in conventional materials.

Metamaterials derive their features not from the properties of the basic material of which they are made but from the internal microstructure by which they are constituted, composed of several sub-elements, or cells, which are usually arranged in functional patterns.

The most varied combinations of various parameters, such as shape, geometry, size, cell orientation, and cell architecture are possible, and this allows numerous degrees of freedom in the design of structures built with metamaterials, giving rise to a huge variety of possible mechanical responses, even unusual ones, which are far from being fully explored and understood.

Although the properties of metamaterials and the possibilities they offer for the construction of various types of structures have been widely studied and are the subject of a rather extensive scientific literature, the specific application of metamaterials to the construction of mechanical actuators has been little investigated in the prior art.

The term “mechanical actuator” is used here to indicate a structured metamaterial in which the induced movement of some of its parts determines a predetermined movement of another part.

Historically, humans have always tried to build materials with properties adapted to specific needs, focusing on one or more features, such as strength, hardness, lightness, plasticity or elasticity.

A revolutionary approach that has emerged in recent years has focused the attention on materials structured on micro-scale or meso-scale or macro-scale, i.e., the mentioned mechanical metamaterials, which can be seen as a new class of artificial materials, engineered to have exceptional properties and responses which cannot be found in nature.

The properties of such metamaterials, such as stiffness, strength-to-weight ratio, elastic response or Poisson ratio, can be tuned to provide, or even exceed and improve, the properties found in conventional materials.

As already observed, metamaterials derive their characteristics not so much from the properties of the basic materials of which they are made, but from their innovative internal structure, consisting of multiple sub-elements, or cells, which are usually arranged in functional patterns.

Typically, man-made metamaterials are drawn with a single pattern periodically repeated throughout the material, either by serially repeating cellular patterns or by placing gaps or holes in a regular arrangement.

Interest in metamaterials is further stimulated by recent developments in digital manufacturing technologies, e.g., 3D printing, which allow for easier design of such material structures with the removal of many of the scale and geometry constraints, and with a significant reduction in manufacturing costs.

A decisive conceptual advance in this sense is that of “metamaterial machines” (Cf., for example, the article “Metamaterial mechanisms” A. Ion et al.-Proceedings of the 29^{th} Annual Symposium on User Interface Software and Technology, p. 529-539), capable of implementing mechanical functions through the transformation of input stimuli and movements into a programmable and/or predictable output.

In this case, the constituent cells operate together in a well-defined order to achieve the final controlled directional macroscopic movement.

The advantage of using a metamaterial machine derives from a drastic reduction in assembly complexity because such a machine can also consist of a single element.

Metamaterial machines find natural application in human-machine interactions as interactive/responsive components. They can be used to transform mechanical/tactile signals from a user to a machine and vice versa from a machine to a user.

The current strategies, provided by prior art, for the design of structures and/or metamaterial machines are based on the experience and talent of the designer (for example, refer again to the article by A. lon et al. mentioned above). This approach is clearly insufficient to ensure industrial-scale designs and applications of metamaterial machines, and, furthermore, does not guarantee the optimization of implementation efficiency.

In brief, the application of metamaterials to metamaterial machines (or to metamaterial actuators, which constitute the basic element thereof) requires not only a specific analysis of the mechanical response of a metamaterial, but a specific evaluation or simulation of the mechanical response of a structure formed by metamaterial cells, intended to form the mechanical actuator, taking into account the many parameters and degrees of freedom of the structure itself.

In particular, there is a strong need to devise an automated methodology, computer-implemented and assisted by advanced and not excessively burdened computational techniques, to design a mechanical actuator with a desired input/output mechanical response and with optimized performance according to predetermined criteria.

The need is further felt to make such actuators, on the basis of the aforesaid design methodology, thereby obtaining the technical advantage of having low-cost mechanical actuators, of considerable versatility, and with accurate and optimized mechanical responses for a specific purpose.

The aforesaid requirements are not fully met by the prior art known to date.

### SUMMARY OF THE INVENTION

It is the object of the present invention to provide a computer-implemented method for automated design of a mechanical actuator constituted by metamaterial, which makes it possible to solve, at least in part, the drawbacks described above with reference to the prior art and to respond to the aforesaid needs particularly felt in the technical sector considered. Such an object is achieved by a method according to claim 1.

Further embodiments of such a method are defined in claims 2-19.

It is a further object of the present invention to provide a method for making a mechanical actuator by using metamaterials, employing a method according to one of claims 1-19. Such a method is defined in claim 20. Further embodiments of such a method are defined in claims 21-22.

It is a further object of the present invention to provide a method for making a metamaterial machine comprising mechanical actuators. Such a method is defined in claim 23.

### BRIEF DESCRIPTION OF THE DRAWINGS

Further features and advantages of the method and system according to the invention will be apparent from the following description which illustrates preferred embodiments, given by way of indicative, non-limiting examples, with reference to the accompanying figures, in which:

FIG. 1 shows an initial lattice model formed by metamaterial, used in an embodiment of the method according to the invention;

FIGS. 2A, 2B and 2C respectively show an initial lattice formed by metamaterial, a lattice modified by means of an embodiment of the design method of the present invention, and a FEM simulation of the mechanical behavior of the designed lattice;

FIG. 3 shows a plurality of curves representative of the evolution of an efficiency parameter, obtained by means of numerous executions of the method according to the invention;

FIG. 4 shows an example of lattice reconfiguration in case of removal of a bean;

FIGS. 5 and 6 show two examples of comparison of automatic design (using the method of the invention) and human design of mechanical actuator; the respective mechanical response simulations are also shown.

### DETAILED DESCRIPTION

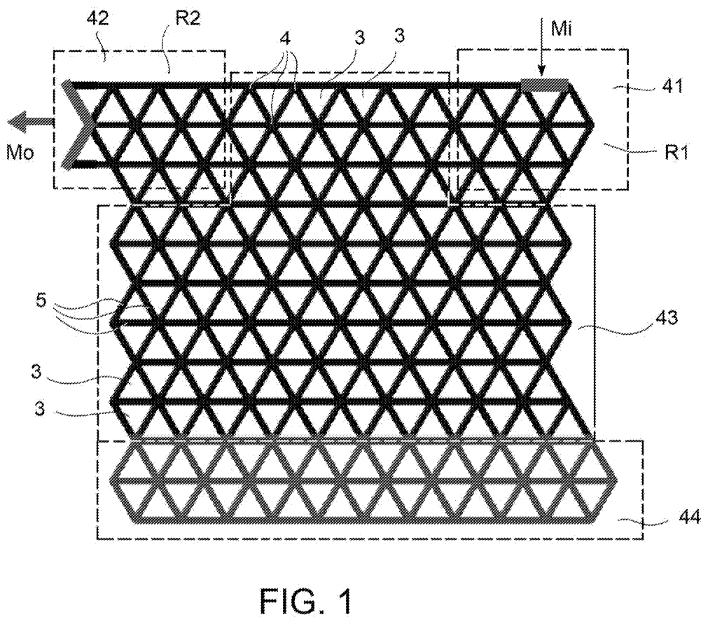

A computer-implemented method for an automated design of a mechanical actuator 1 formed by lattice-structured metamaterial is described with reference to FIGS. 1-6.

Such a method firstly comprises the step of defining an initial lattice model 2 formed by the aforesaid metamaterial, constituted by the repetition of basic geometric elements 3, either regular or non-regular, two-dimensional or three-dimensional, formed by a plurality of nodes 4 connected by a plurality of beams 5.

Then, the method provides defining, among the nodes 4 of the aforesaid lattice, the following groups of nodes: at least one first group of input nodes 41, which constitute a respective at least one input region R1 intended to receive a respective at least one input mechanical stimulus Mi; at least one second group of output nodes 42, which constitute a respective at least one output region R2 intended to provide a respective at least one desired output mechanical movement Mo, as a result of the action of the actuator; and a third group of removable nodes 43, distinct from the aforesaid nodes of the first group and of the second group.

The method then comprises iterating a plurality of steps which will be described below.

In the iteration, the step of modifying a current test lattice is performed, on the basis of a pseudo-random decision determined by means of a computational algorithm, to obtain a modified test lattice.

Such a step of modifying comprises either removing or adding a node belonging to the third group of removable nodes and/or either removing or adding a beam afferent to a node belonging to the third group of removable nodes, and accordingly reconfiguring the beams afferent to the removed or added node or to the nodes associated with the removed or added beam.

There is then provided the step of simulating, by means of computational simulation (performed by means of an electronic processor), the mechanical response of the modified test lattice, when at least one input mechanical stimulus is applied to the input nodes of the at least one first group 41, to determine the consequent at least one output mechanical movement of the output nodes of at least one second group 42, and to establish the position of the input and output nodes of the modified test lattice in presence of the aforesaid at least one input mechanical stimulus.

A figure of merit of the modified test lattice is then calculated, on the basis of the positions, established by the aforesaid simulation, of the input and output nodes, in presence of the at least one input mechanical stimulus.

Then, the step is performed of either accepting or rejecting the modified test lattice, or establishing a probability of acceptance of the modified test lattice, on the basis of a comparison between the figure of merit of the current test lattice and the figure of merit of the modified test lattice.

In conclusion of the whole of the steps which are iterated, the current test lattice for the subsequent iteration is defined as the initial lattice at the first iteration, or, in subsequent iterations, as the present current test lattice if the modified test lattice was rejected, or as the modified test lattice if it was accepted.

The aforesaid iteration comprises at least one step in which a previously removed node is added again.

Furthermore, the aforesaid iteration is repeated until a predetermined optimization criterion of the figure of merit is met.

At the end of the iteration, the method provides considering the current test lattice determined by the last iteration as the final design model of the mechanical actuator 1 and providing digital data corresponding to the aforesaid final design model for manufacturing the mechanical actuator by metamaterial.

According to an embodiment, the method comprises a further step of defining a fourth group of support nodes 44, configured to act as a support for the mechanical actuator 1, and which are kept unchanged and in a fixed position during the steps of the aforesaid iteration.

In such a case, the third group of removable nodes 43 is constituted by nodes which belong neither to the first group, nor to the second group, nor to the third group.

According to an embodiment of the method, the aforesaid step of defining a model of an initial lattice 2 comprises defining a model of a regular initial lattice 2, formed by a metamaterial and constituted by the repetition of regular basic geometric elements 3.

According to an implementation option, the regular basic geometric element 3 (that can also be defined as a “cell”) which, if repeated, forms the initial lattice, comprises a triangular 2D element or a hexagonal 2D element.

According to another implementation option, the basic regular geometric element 3 (that can also be defined as a “cell”) which, by repeating, constitutes the initial lattice comprises a 3D cubic element with centered faces or a 3D cubic element with a centered body.

According to an embodiment of the method, each of the input nodes of the first group of nodes 41 is configured to receive, as input mechanical stimulus Mi, a mechanical actuator external activation force F, and to move towards a predetermined input stimulus direction defined by an input vector tᵢₙₚ when the aforesaid external force F is applied.

Each of the output nodes of the second group of nodes 42 is configured to move, as output movement Mo, towards a predetermined output movement direction defined by an output vector tₒᵤₜ when the mechanical actuator is activated through the application of the aforesaid external force F.

According to an embodiment of the method, the lattice comprises a plurality of N first groups of nodes 41 and a plurality of M second groups of nodes 42, wherein said N first groups of nodes are associated with a respective plurality of N input regions R1ₙ (n=1, N), and the M second groups of nodes are associated with a respective plurality of M output regions R2ₘ (m=1, M).

In this case, the input nodes of each of the N input regions R1ₙ are configured to receive, as respective input mechanical stimulus Miₙ, a respective external activation force Fₙ, and to move towards a predetermined respective input stimulus direction defined by a respective input vector t_{inp,n}, when the aforesaid external force Fₙ is applied.

The output nodes of each of the M output regions R2ₘ are configured to move, as respective output movement Moₘ, towards a predetermined respective output movement direction defined by a respective output vector t_{out,m} when the mechanical actuator is activated through the application of one or more of the external forces Fₙ.

In other words, as illustrated above, the method is applied to the design of lattices (and thus actuators) which can be activated by a plurality of N stimuli, also not parallel to one another, applied to respective input regions and/or nodes, to determine a plurality of desired M output movements, also not parallel to one another (given to respective output regions and/or nodes).

According to an implementation option, each input region R1ₙ comprises a respective input node.

According to an implementation option, each output region R2, comprises a respective output node.

According to an implementation option, the aforesaid step of modifying a current test lattice is performed on the basis of a pseudo-random decision determined by a computational algorithm of the Monte-Carlo type.

According to an embodiment of the method, the step of simulating the mechanical response of the test lattice is performed by means of an FEM-type simulation (finite element methods).

According to another embodiment of the method, the step of simulating the mechanical response of the test lattice is performed by means of a simulation based on a discrete element model (DEM).

According to an implementation option of the aforesaid embodiment, the simulation based on a discrete element model (DEM) comprises performing a “conjugated gradient relaxation”, i.e., minimizing an appropriate “lattice total energy” function.

Advantageously, according to an embodiment of the method, the step of modifying a current test lattice is performed on the basis of a pseudo-random decision determined by a Monte-Carlo computational algorithm, and the step of simulating the mechanical response of the test lattice is performed by a simulation based on a discrete element model (DEM).

According to an implementation option, wherein the calculated figure of merit, for each test lattice, comprises a structure efficiency, depending on the aforesaid input stimulus direction tᵢₙₚ and output movement direction tₒᵤₜ and on the displacements of the input nodes rᵢ-r₀ᵢ and of the output nodes rⱼ-r₀ⱼ relative to the respective initial position.

According to an implementation option, if more input regions and more output regions are provided, the efficiency is calculated as dependent on the plurality of input stimulus directions t_{inp,n} and on the plurality of output movement directions t_{out,m,} and also on the displacements of the nodes of the various groups of input nodes (r_{i,n}-r_{0i,n}) and on the displacements of the nodes of the various groups of input nodes (r_{j,m}-r_{0j,m}) relative to their respective initial position.

According to another implementation option, the calculated figure of merit for each test lattice comprises a “directional efficiency” (η_{d}), which will be defined in detail hereafter.

According to another implementation option, the calculated figure of merit for each test lattice comprises a “force-based efficiency” (η_{f}), which will be defined in detail hereafter.

According to an embodiment of the method, the step of accepting or rejecting the modified test lattice, or establishing a probability of acceptance of the modified test lattice, comprises defining a cost function Δ (an example of which will be provided hereafter in the description) and then calculating a current cost function value Δ⁰ of the current lattice and a test cost function value Δ^{trial} of the modified test lattice; then applying the following acceptance or rejection criterion: if Δ^{trial}<Δ⁰ the change is accepted; if Δ^{trial}>Δ⁰ the change is accepted with a given probability P (about which further details will be provided hereafter).

According to an embodiment of the method, the criterion of optimization of the figure of merit, which determines the continuation or stopping of the iteration, is the optimization, or the maximization, of the figure of merit.

According to several possible options of implementation, the metamaterial the lattice is composed of comprises rubber and/or plastic and/or metal.

According to a particular implementation option, the final structure of the lattice model, at the end of the iteration, is further tested by means of simulations of the FEM type.

According to an embodiment of the method, the aforesaid steps of the method are performed by one or more simulation and/or optimization algorithms executed by a computer.

A method for making a mechanical actuator using metamaterials is now described.

Such a method comprises the steps of executing a method for automated design of a mechanical actuator according to any one of the embodiments illustrated above; and manufacturing the mechanical actuator on the basis of the digital data corresponding to the final design model of the mechanical actuator, provided by the aforesaid method for the automated design of a mechanical actuator.

According to an implementation option of such a method, the step of manufacturing comprises manufacturing the mechanical actuator 1 by means of 3D printing techniques.

According to another implementation option of such a method, the step of manufacturing comprises manufacturing the mechanical actuator by extrusion and/or pressing and/or carving techniques.

A method for making a metamaterial machine comprising mechanical actuators is now described.

Such a method comprises the steps of manufacturing one or more mechanical actuators 1 according to any one of the embodiments illustrated above; and making the metamaterial machine by integrating the aforesaid one or more mechanical actuators and other parts of the machine.

The invention further comprises a system configured to perform the automated design method of a mechanical actuator described above, comprising electronic processing means provided with at least one processor configured to execute software programs adapted to implement the algorithms and steps of the method described above.

The invention further comprises a system configured to perform the method of making a mechanical actuator, comprising, in addition to the aforesaid electronic processing means, 3D printing means or means for making a mechanical actuator, as described above.

Further details of the method according to the invention are described below, as non-limiting examples.

As already noted, the solution described herein involves automatically designing an actuator on the basis of the simulated response of the material.

The starting point is a regular lattice (grid) model, on which an input-output movement is simulated and the respective efficiency is calculated.

Then, the efficiency of the structure is iteratively optimized by randomly removing or adding one of its sub-elements or cells (or one of the nodes or one of the beams that make up the cells) and checking whether the efficiency has increased or not.

After this error minimization approach based on random attempts, the desired input-output response is optimized.

The mathematical principles adopted to guide this procedure ensure that the achieved efficiencies are the highest, in principle.

The lattice model thus obtained can be further tested by means of appropriate computational simulations.

The lattice model can finally be manufactured, for example by means of 3D printing or other manufacturing processes.

According to an embodiment, a Monte-Carlo (MC) method combined with conjugated gradient optimization is used to automatically design the actuator to obtain a functional metamaterial structure through an iterative process.

It starts with a lattice model consisting of N nodes 4 connected by n beams (or segments) 5.

According to different implementation options, the lattice is two-dimensional or three-dimensional, and has any kind of geometry, e.g.: 2D triangular, 2D hexagonal, 3D cubic face-centered, 3D cubic body-centered, and so on.

According to other possible implementation options, amorphous or random lattices can also be used as an initial lattice structure.

The initial lattice structure has coordinates R_{IS}.

The length of the beams is, for example, constant, and equal to r₀.

The position of the i-th node is indicated by the vector rᵢ having coordinates (xᵢ, yᵢ).

The distance between two nodes is rᵢⱼ=|rⱼ−rᵢ|.

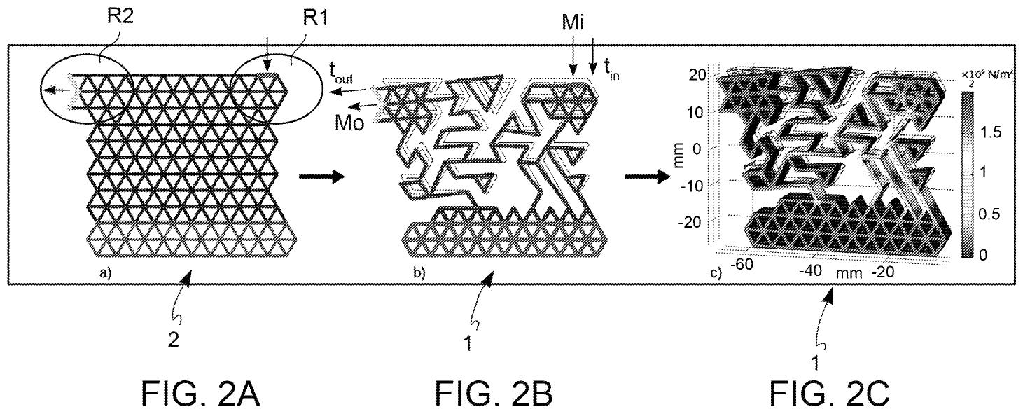

For example, according to an embodiment, illustrated in FIG. 2A, the starting model comprises a triangular lattice (i.e., made up of elements or cells with a triangular cross-section), mechanically stable, which can be seen as composed of beams and nodes, as described above.

Then, two nodes or groups of nodes are chosen, respectively representing an input region R1 (intended to receive an input mechanical stimulus E) and an output region R2 (intended to provide a desired output mechanical movement Mo, as a result of the actuator action).

The first group of nodes 41, also defined here as “input nodes” (comprising, for example, an i-th node) is configured to be displaced towards a predetermined first direction defined by a first vector tᵢₙₚ when an external force is applied to activate the actuator.

The second group of nodes 42, also defined here as “output nodes” (comprising, for example, a j-th node) is configured to move towards a predetermined second direction defined by a second vector tₒᵤₜ when the actuator is activated through the above-mentioned stimulus acting on the input nodes.

According to an implementation option, the starting lattice also defines an additional group of nodes 44, named “support nodes”, which act as support for the actuator, and therefore must be kept unchanged and in a fixed position during the subsequent simulated evolutions of the actuator.

Nodes which do not belong to the aforesaid mentioned first, second and third groups can be modified (e.g., eliminated) during the attempts performed to optimize the structure, and thus belong to a further group of removable nodes 43 (defined in this description as the third group of nodes 43).

The aforesaid groups of nodes are shown in FIG. 2A, together with an example of input bias Mi and output movement Mo.

Starting from the initial lattice, the optimization algorithm proceeds with the random selection of a node, belonging to the aforesaid third group, or of a beam (afferent to two nodes belonging to the aforesaid third group) to be eliminated. Thus, the node is eliminated, and the mechanical behavior of the modified structure without the aforesaid node is simulated. Then, a figure of merit value of the modified structure is calculated and compared with the initial value of the figure of merit. The modification is either accepted or not according to the result of the comparison between the figures of merit of the modified structure and the initial one, based on a predetermined criterion.

The steps of randomly selecting a node or beam to be deleted, calculating a figure of merit of the modified structure, comparing with the figure of merit value of the modified structure in the preceding step, and deciding whether or not to keep the last modification made are iterated until an optimal state is achieved.

An example of a structure obtained at the end of the optimization process is shown in FIG. 2B.

Several options are possible with reference to the aforesaid figures of merit and optimization criteria.

According to an option, the figure of merit is the efficiency of the structure, defined as:

$$η = \frac{{t}_{out} \cdot ( {r}_{j} - {r}_{0 j} )}{{t}_{inp} \cdot ( {r}_{i} - {r}_{0 i} )}$$

where rⱼ-r₀ⱼ and rᵢ-r₀ᵢ are the displacements of the input and output nodes i and j from the initial position, tᵢₙₚ and tₒᵤₜ are the aforesaid first and second direction, and the scalar products are averaged over the number of input and output nodes.

According to another option, a “directional efficiency” η_{d} defined as:

$${η}_{d} = \frac{\vert {r}_{j} - {r}_{0 j} \vert f ( γ )}{{t}_{inp} \cdot ( {r}_{i} - {r}_{0 i} )}$$

wherein the scalar product is replaced by a weight function,

ƒ(γ)=(2 cos(γ/2)n−1),n≥2

and wherein y is the angle between the desired output direction tₒᵤₜ and the measured direction.

Such a directional efficiency is related to the maximization of the output displacement towards the desired direction.

It is worth noting that for n>2, the weight of the output movement along the desired output direction is reinforced tₒᵤₜ. For n=2, the case corresponds to the previous case: η=η_{d}.

According to another option, a “force-based efficiency” η_{d} is used, defined as:

$${η}_{f} = \frac{{k}_{ext} \vert {r}_{j} - {r}_{0 j} \vert f ( γ )}{{F}_{ext}}$$

where kₑₓₜ is an elastic spring constant and Fₑₓₜ is a constant input force.

In this case, the requirement that the force exerted on the input nodes is efficiently propagated on the output nodes towards the objective direction is emphasized. This is especially advantageous when the actuator is expected to be integrated with other mechanical parts, forming a larger mechanism.

Therefore, in this case, a constant force is applied in the simulation on the input nodes and the force on the output nodes is measured by means of monitoring springs, acting as dynamometers. This corresponds to adding the energy term to the input nodes

Eₒᵤₜ=Fₑₓₜ[tᵢₙₚ·(rᵢ−r₀ᵢ)]

and adding the energy term to the output nodes

$${E}_{o u t} = \frac{1}{2} {{k}_{ext} ( A B S ( {t}_{o ι ι t} ) \cdot ( {r}_{j} - {r}_{0 j} ) )}^{2}$$

with the criterion of minimizing energy, hence the definition of η_{f} above.

An optimization criterion is defined once an appropriate efficiency function has been chosen (e.g., one of those mentioned above).

According to an implementation option, the efficiency is maximized by minimizing a cost function Δ.

According to a particular implementation example, the cost function is Δ=exp(−η).

In this case, the minimization protocol used by the optimization algorithm is as follows: at each step, from a current configuration (i.e., initial configuration) with Δ=Δ⁰, a test configuration is obtained by removing or adding a randomly chosen beam. The input nodes, output nodes, and support nodes (for example, the three rows of nodes in the lower part of FIG. 2A) are excluded from the pruning; the support nodes are also constrained to immobility.

The algorithm then provides displacing the input nodes in the direction tᵢₙₚ (or applying an external force to them in the case of optimization of η_{f}), then performing a conjugate gradient relaxation, then measuring the displacement of the output nodes (or the force on them through the monitoring springs η_{f} in case of optimization of η_{f}).

Then, the algorithm calculates the efficiency and the corresponding modified cost function of the test configuration Δ^{trial}.

The condition of acceptance or non-acceptance of the imposed random change comprises a comparison between the initial and modified values of the cost function:
if Δ^{trial}<A⁰ the modification (removal or addition) of the beam is accepted;
if Δ^{trial}>Δ⁰ the modification (removal or addition) of the beam is accepted with a probability P, calculated as:

P=exp[−(Δ^{trial}−Δ⁰)/T].

The aforesaid iterative procedure can be interrupted when a certain criterion is reached, e.g., when a maximum number of iterations is reached or the desired efficiency value is obtained.

The parameter T determines the probability that the test configuration can be accepted even if the efficiency is lower than in the previous configuration. Since it may happen that the procedure is not convergent at finite values of T, in some typical implementation examples, T is decreased, starting from a large initial value, allowing in principle the exploration of the entire phase space of the configurations up to a small or zero value, in such a way to certainly allow the convergence of the procedure.

For example, at the beginning of each iteration/optimization procedure, in order to explore possible efficiencies, a large number (e.g., 100) MC (Monte-Carlo) simulation annealing cycles are performed, with the parameter T decreasing linearly from a value of 0.06 (a threshold which makes it possible to obtain a maximum consistent probability value equal to 1) up to a value of 0.001, then allowing the algorithm to evolve at the lowest T (“temperature”) parameter.

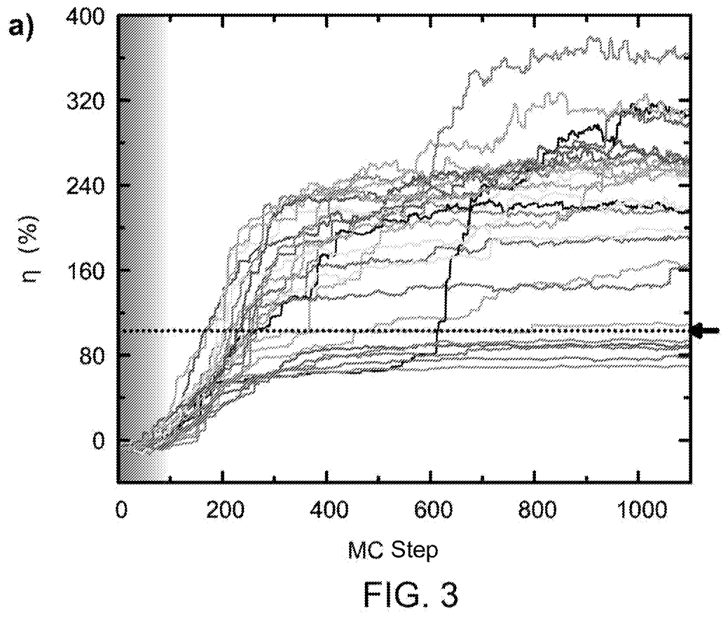

The entire procedure is repeated several times using different seeds to generate random numbers. The results obtained from the repetition of the aforesaid procedures are shown in FIG. 3.

According to an embodiment, the sequence of random modifications comprises both the removal and the addition of beams between nodes.

As previously indicated, the algorithm must determine the displacement of each output node in response to a certain input stimulus applied to the input nodes to calculate the efficiency.

In this regard, any appropriate theoretical model can be used, even known in itself (with characteristics of different compromise between accuracy and speed). Such a model can take into account different parameters of the metamaterial, such as compressibility modulus, Poisson ratio, density, and so on.

According to an implementation option, such a step of determining a mechanical response is carried out by means of a FEM simulation (finite element methods).

Such a simulation type allows to carry out realistic simulations of the mechanical response of the modeled structures.

For example, known FEM simulators such as COMSOL Multiphysics and COMSOL with MATLAB can be used through the use of a structural mechanics module.

Such simulations and analyses assume that the metamaterial is a linear elastic material with Young's modulus and Poisson's ratio experimentally estimated for samples is of interest.

Such simulations can use, for example, Eulero-Bernouilli beams (beam elements) using “stationary study” simulation modules (quasi-static solver).

As studies of the instability force, solid mechanical models can be used in conjunction with instability resolution modules. Appropriate loading conditions shall be used for the trabecular structure in the area under consideration.

According to another implementation option, the aforesaid step of determining a mechanical response is carried out using a discrete element model (DEM) in the manner shown hereafter.

Each beam is modeled as a spring acting between two connected nodes. In this case, the elastic energy term of each beam is:

ϕ₂(r_{i,j})=k(r_{i,j-r}_{₀}₎²

where r₀ is the length of the beam in the original unperturbed configuration.

According to a particular implementation example, to take into account the angular efforts, the model uses terms of three bodies angular energy evaluated between two beams connected to the same node:

ϕ₃(rᵢⱼ,rᵢₖ,θᵢⱼₖ)=λ[θᵢⱼₖ−θᵢⱼₖ⁰]²

where θᵢⱼₖ is the angle formed by the beams ij and ik and θᵢⱼₖ⁰ is the initial value of the angle in the unperturbed lattice.

In order to determine the mechanical response of the output nodes, relative to a given movement of the input nodes, a “conjugated gradient relaxation” is performed, i.e., the “total energy” function of the lattice expressed by the following relation is minimized:

$$E = {\sum }_{i} {\sum }_{j > i} {ϕ}_{2} ( {r}_{ij} ) + {\sum }_{i} {\sum }_{j > i} {\sum }_{k \neq j} {ϕ}_{3} ( {r}_{ij} , {r}_{ik} , {θ}_{ijk} )$$

where i and j represent all possible pairs of adjacent nodes.

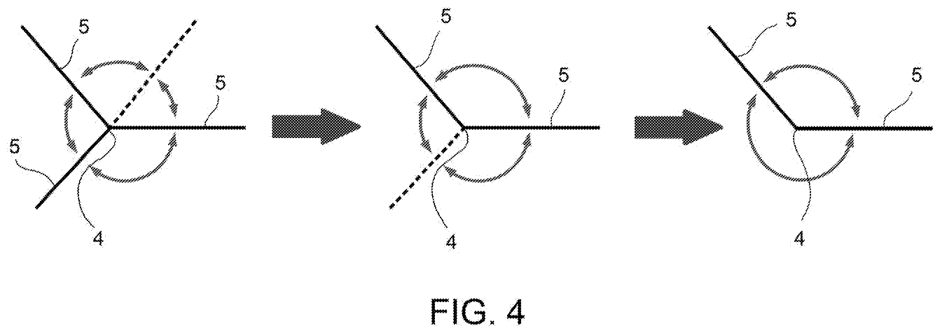

According to an implementation example, both the aforesaid elastic energy terms Φ₂ and Φ₃ act between pairs of nodes immediately adjacent to one another, with the three bodies neighbors recalculated at each step (as shown in FIG. 4).

The aforesaid parameters k and λ, used in the definitions of the elastic energy terms Φ₂ and Φ₃, can be adjusted according to the material used to manufacture the actuator.

According to an implementation example, the following values are used: k=5; λ=0.1; r₀=1.

Examples of results which can be obtained using a method according to the present invention are shown below.

Consider two prototype actuators, the first where the desired inputs and outputs are orthogonal (tᵢₙₚ=−y, tₒᵤₜ=−x) and the second where the desired inputs and outputs are anti-parallel (tᵢₙₚ=−y, tₒᵤₜ=y).

FIG. 3 shows the evolution of the efficiency n during the MC dynamics for different implementations of functional lattices with orthogonal configuration (lattice with anti-parallel configuration determine similar traces).

It is worth noting that, after the step of annealing, the efficiency tends to evolve in steps, interspersed with noisy parts and flat stretches.

The steps (or “jumps”) can occur when a mechanism that engages the desired response is eventually activated, while flat stretches indicate a strong structure compared to removing or adding one or more links.

As a result, the reference samples can be advantageously chosen from configurations along such flat stretches.

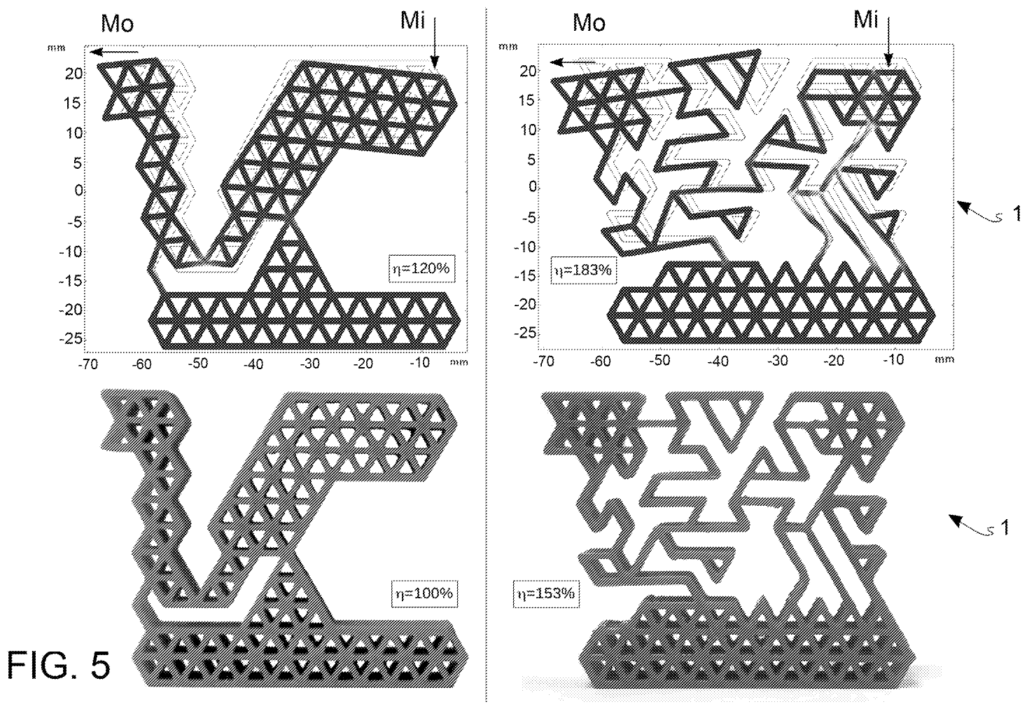

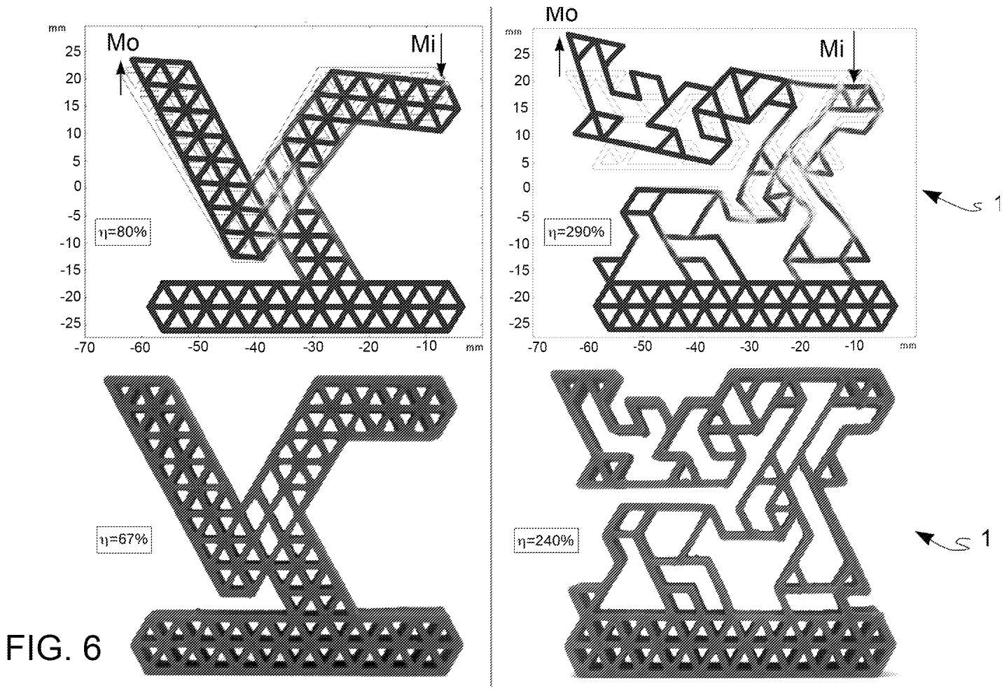

It is worth noting that the achievable efficiency can easily approach and even exceed values obtained from structures designed by a human (as shown in the examples shown in FIGS. 5 and 6).

Furthermore, wide variability of the final efficiency values can be obtained, thus indicating traps of local minimums to escape from which a “thermal excitation” is required.

Because of this, depending on the post-annealing conditions, the exploration of the entire phase space of the mesh can take a very long time, which grows as the size of the mesh increases.

In FIGS. 5 and 6, the results obtained from projects made by humans (left part of the figures) and from projects made by the machine, according to the present method (right part of the figures), are compared for cases of orthogonal and anti-parallel movements, respectively.

In the upper parts of each of the left and right columns of FIGS. 5 and 6, the results of a FEM simulation of mechanical behavior are shown.

In the lower parts of each of the right and left columns in FIGS. 5 and 6, the actuator structures as obtained from the respective designs and made with 3D printing are shown.

It is worth noting that when using simplified models during iterations of the optimization algorithm, it is appropriate to validate the results through more refined simulations. For such a purpose, the structures have been converted to “FEM mesh” to simulate the realistic material and structure response.

In all the cases considered above, the efficiencies calculated by the model were validated through FEM simulations.

One of the advantages of FEM simulations is the possibility to obtain information about the propagation of the force along the mesh and to identify the regions most involved in the implementation of the mechanism.

In this respect, it is worth noting that the automatically generated structures are characterized by a wide distribution of the force, which indicates a collective engagement of the mesh.

On the contrary, in the structures designed by humans, the effort highlights the few focal points used to perform the movement.

As can be noted, the object of the present invention is fully achieved by the methods illustrated above by virtue of the functional and structural features thereof.

Indeed, the method for the automated design of mechanical actuators described above can meet the need for an automated method, assisted by advanced computational techniques performed by electronic processing, to design a mechanical actuator with a desired mechanical input/output response and with optimized performance according to predetermined criteria, exploiting in the best way the possibilities and advantages provided by the use of metamaterials.

Furthermore, the aforesaid method makes it possible to obtain effective project results by reducing computational complexity and burden, which are a drawback of other known solutions.

In this regard, the embodiment of the present method which comprises the synergistic combination of Monte-Carlo methods (for the step of modifying the test lattice) and discrete element simulations (for the step of simulating the mechanical response of the test lattice), is particularly advantageous.

The combination of these two algorithms leads to particularly advantageous results, which are able to overcome some important disadvantages of known solutions, such as:
limited efficiency in finding the optimized solution in terms of time;
heavy computational burden, which may impede the ability to operate on a large scale.

These obstacles are overcome by virtue of the method illustrated above, which can provide much more efficient solutions than known solutions, under the same initial conditions of problem definition.

Furthermore, the method for the making mechanical actuators described above can satisfy the need to make such actuators, to provide mechanical actuators at low cost, of remarkable versatility, and with accurate and optimized mechanical responses for a specific purpose.

A person skilled in the art may make changes and adaptations to the embodiments of the methods described above or can replace elements with others which are functionally equivalent to satisfy contingent needs without departing from the scope of protection of the appended claims. All the features described above as belonging to one possible embodiment may be implemented independently from the other embodiments described.

1. A computer-implemented method for automated design of a mechanical actuator formed by lattice-structured metamaterial, wherein the method comprises the steps of:
defining a model of an initial lattice of said metamaterial and constituted by the repetition of basic geometric elements, either two-dimensional or three-dimensional, formed by a plurality of nodes connected by a plurality of beams;
defining, among the nodes of said lattice, the following groups of nodes:
at least one first group of input nodes, which constitute a respective at least one input region (R1) intended to receive a respective at least one input mechanical stimulus (Mi);
at least one second group of output nodes, which constitute a respective at least one output region (R2) intended to provide a respective at least one desired output mechanical movement (Mo), as a result of the action of the actuator;
a third group of removable nodes, distinct from said nodes of the first group and of the second group;
wherein the method further comprises the iteration of the following steps:
modifying a current test lattice, on the basis of a pseudo-random decision determined by means of computational algorithm, to obtain a modified test lattice,
wherein said step of modifying comprises either removing or adding a node belonging to the third group of removable nodes and/or either removing or adding a beam afferent to a node belonging to the third group of removable nodes, and accordingly reconfiguring the beams afferent to the removed or added node or to the nodes associated with the removed or added beams;
simulating, by means of computational simulation, the mechanical response of the modified test lattice, when at least one input mechanical stimulus is applied to said input nodes of the at least one first group, to determine the consequent at least one output mechanical movement of said output nodes of at least one second group, and to establish the position of the input and output nodes of the modified test lattice in presence of said at least one input mechanical stimulus;
calculating a figure of merit of the modified test lattice, on the basis of the positions, established by said simulation, of the input and output nodes, in presence of at least one mechanical input stimulus;
either accepting or rejecting the modified test lattice, or establishing a probability of acceptance of the modified test lattice, on the basis of a comparison between the figure of merit of the current test lattice and the figure of merit of the modified test lattice;
defining the current test lattice for the subsequent iteration as the initial lattice at the first iteration, or, in subsequent iterations, as the present current test lattice if the modified test lattice was rejected, or as the modified test lattice if it was accepted;
wherein said iteration comprises at least one step in which a previously removed node is added again, and in which said iteration is repeated until a predefined criterion for optimizing the figure of merit is met;
at the end of the iteration, considering the current test lattice determined by the last iteration as final design model of the mechanical actuator, and providing digital data corresponding to said final design model of the mechanical actuator for manufacturing the mechanical actuator by metamaterial.

2. A method according to claim 1, comprising the further step of defining a fourth group of support nodes, configured to act as a support for the mechanical actuator, and which are kept unchanged and in a fixed position during the steps of said iteration,
and wherein the third group of removable nodes is constituted by nodes belonging neither to the first group, nor to the second group, nor to the third group.

3. A method according to claim 1, wherein said step of defining an initial lattice model comprises:
defining a model of a regular initial lattice, formed by a metamaterial and constituted by the repetition of regular basic geometric elements.

4. A method according to claim 3, wherein the basic regular geometric element which, by repeating, constitutes the regular initial lattice comprises a 2D triangular element or a 2D hexagonal element.

5. A method according to claim 3, wherein the basic regular geometric element which, by repeating, constitutes the regular initial lattice comprises a 3D cubic element with centered faces or a 3D cubic element with centered body.

6. A method according to claim 1, wherein:
each of the input nodes of the first group of nodes is configured to receive, as input mechanical stimulus (Mi), an external activation force (F) of the mechanical actuator, and to move towards a predetermined input stimulus direction defined by an input vector (tᵢₙₚ) when said external force F is applied;
each of the output nodes of the second group of nodes is configured so as to move, as output movement (Mo), towards a predetermined output movement direction defined by an output vector (tₒᵤₜ) when the mechanical actuator is activated by means of the application of said external force (F).

7. A method according to claim 1, wherein the lattice comprises a plurality of first groups of nodes and a plurality of second groups of nodes, said first groups of nodes being associated with a respective plurality of input regions (R1ₙ), and said second groups of nodes being associated with a respective plurality of output regions (R2ₘ);
the input nodes of each of said input regions (R1ₙ) are configured to receive, as respective input mechanical stimulus (Miₙ), a respective external activation force (Fₙ), and to move towards a predetermined respective input stimulus direction defined by a respective input vector (t_{inp,n}) when said external force (Fₙ) is applied;
the output nodes of each of these output regions (R2ₘ) are configured so as to move, as the respective output movement (Moₘ), towards a predetermined respective output movement direction defined by a respective output vector (t_{out,m}) when the mechanical actuator is activated by means of the application of one or more of said external forces (Fₙ).

8. A method according to claim 1, wherein the step of modifying a current test lattice is performed based on a pseudo-random decision determined by a computational algorithm of the Monte-Carlo type.

9. A method according to claim 1, wherein the step of simulating the mechanical response of the test lattice is performed by means of a simulation based on a discrete element model, DEM.

10. A method according to claim 9, wherein the step of simulating the mechanical response of the test lattice is performed by means of a simulation based on a discrete element model, DEM, and the simulation based on a discrete element model, DEM, comprises performing a “conjugate gradient relaxation”, i.e., the minimization of the “total energy” function of the lattice.

11. A method according to claim 1, wherein the calculated figure of merit, for each test lattice, comprises a structure efficiency, depending on said input stimulus direction (tᵢₙₚ) and output movement direction (tₒᵤₜ) and on the movements of the input nodes (rᵢ−r₀ᵢ) and of the output nodes (rⱼ−r₀ⱼ) with respect to the respective initial position.

12. A method according to claim 10, wherein said structure efficiency (η) is calculated according to the following formula:
$$η = \frac{{t}_{out} \cdot ( {r}_{j} - {r}_{0 j} )}{{t}_{inp} \cdot ( {r}_{i} - {r}_{0 i} )}$$

13. A method according to claim 1, wherein the calculated figure of merit, for each test lattice, comprises a “directional efficiency”
$${η}_{d} = \frac{\vert {r}_{j} - {r}_{0 j} \vert f ( γ )}{{t}_{inp} \cdot ( {r}_{i} - {r}_{0 i} )}$$
(η_{d}) defined as:
wherein f is a weight function defined as
ƒ(γ)=(2 cos(ƒ/2)n−1),n≥2

14. A method according to claim 1, wherein the calculated figure of merit, for each test lattice, comprises a “force-based efficiency” (η_{f}) defined as:
$${η}_{f} = \frac{{k}_{ext} \vert {r}_{j} - {r}_{0 j} \vert f ( γ )}{{F}_{ext}}$$
where kₑₓₜ is an elastic spring constant and Fₑₓₜ is a constant input force.

15. A method according to claim 10, wherein the step of accepting or rejecting the modified test lattice, or establishing a probability of acceptance of the modified test lattice, comprises:
defining a cost function Δ, for example Δ=exp(η), and calculating a current cost function value)(Δ⁰) of the current lattice and a test cost function value (Δ^{trial}) of the modified test lattice;
applying the following acceptance or rejection criterion: if Δ^{trial}<Δ₀ the change is accepted; if Δ^{trial}>A⁰ the change is accepted with a probability P=exp[−(Δₜᵣᵢₐₗ−Δ⁰)/T].

16. A method according to claim 1, wherein the optimization criterion of the figure of merit, which determines the continuation or stopping of the iteration, is the optimization, or the maximization, of the figure of merit.

17. A method according to claim 1, wherein the metamaterial of which the lattice is composed comprises and/or plastic and/or metal.

18. A method according to claim 1, wherein the final structure of the lattice model, at the end of the iteration, is further tested by means of simulations of the FEM type.

19. A method according to claim 1, wherein said steps of the method are performed by one or more simulation and/or optimization algorithms executed by a computer.

20. A method for making a mechanical actuator by using metamaterials comprising the steps of:
performing a computer method for automated design of a mechanical actuator (1);
manufacturing the mechanical actuator on the basis of the digital data corresponding to the final design model of the mechanical actuator, provided by said method for the automated design of a mechanical actuator
wherein the computer-implemented method for automated design of a mechanical actuator comprises the steps of:
defining a model of an initial lattice of said metamaterial and constituted by the repetition of basic geometric elements, either two-dimensional or three-dimensional, formed by a plurality of nodes connected by a plurality of beams;
defining, among the nodes of said lattice, the following groups of nodes:
at least one first group of input nodes, which constitute a respective at least one input region (R1) intended to receive a respective at least one input mechanical stimulus (Mi);
at least one second group of output nodes, which constitute a respective at least one output region (R2) intended to provide a respective at least one desired output mechanical movement (Mo), as a result of the action of the actuator;
a third group of removable nodes, distinct from said nodes of the first group and of the second group;
wherein the method further comprises the iteration of the following steps:
modifying a current test lattice, on the basis of a pseudo-random decision determined by means of computational algorithm, to obtain a modified test lattice,
wherein said step of modifying comprises either removing or adding a node belonging to the third group of removable nodes and/or either removing or adding a beam afferent to a node belonging to the third group of removable nodes, and accordingly reconfiguring the beams afferent to the removed or added node or to the nodes associated with the removed or added beams;
simulating, by means of computational simulation, the mechanical response of the modified test lattice, when at least one input mechanical stimulus is applied to said input nodes of the at least one first group, to determine the consequent at least one output mechanical movement of said output nodes of at least one second group, and to establish the position of the input and output nodes of the modified test lattice in presence of said at least one input mechanical stimulus;
calculating a figure of merit of the modified test lattice, on the basis of the positions, established by said simulation, of the input and output nodes, in presence of at least one mechanical input stimulus;
either accepting or rejecting the modified test lattice, or establishing a probability of acceptance of the modified test lattice, on the basis of a comparison between the figure of merit of the current test lattice and the figure of merit of the modified test lattice;
defining the current test lattice for the subsequent iteration as the initial lattice at the first iteration, or, in subsequent iterations, as the present current test lattice if the modified test lattice was rejected, or as the modified test lattice if it was accepted;
wherein said iteration comprises at least one step in which a previously removed node is added again, and in which said iteration is repeated until a predefined criterion for optimizing the figure of merit is met;
at the end of the iteration, considering the current test lattice determined by the last iteration as final design model of the mechanical actuator, and providing digital data corresponding to said final design model of the mechanical actuator for manufacturing the mechanical actuator by metamaterial.

21. A method according to claim 20, wherein the step of manufacturing comprises manufacturing the mechanical actuator by means of 3D printing techniques.

22. A method according to claim 20, wherein the step of manufacturing comprises manufacturing the mechanical actuator by means of extrusion and/or pressing and/or carving techniques.

23. A method for making a metamaterial machine comprising mechanical actuators, comprising the steps of:
manufacturing one or more mechanical actuators according to claim 20;
making the metamaterial machine by integrating said one or more mechanical actuators and other parts of the machine.
